(19) United States
(12) Patent Application Publication
(10) Pub. No.: US 2006/0015804 A1
(43) Pub. Date: Jan. 19, 2006

(54) Method and system for presenting editable spreadsheet page layout view

(75) Inventors: Kristopher J. Barton, Sammamish, WA (US); Aaron D. Mandelbaum, Bellevue, WA (US); Tisha A. Abastillas, Mercer Island, WA (US)

Correspondence Address: RONALD M. ANDERSON;MICROSOFT CORPORATION, 600 108TH AVENUE N.E., SUITE 507, BELLEVUE, WA, 98004, US

(73) Assignee: Microsoft Corporation, Redmond, WA (US)

(21) Appl. No.: 10/891,784

(22) Filed: Jul. 15, 2004

(51) Int. Cl. G06F 17/21

(52) U.S. Cl. 715/503

(57) ABSTRACT

A page layout view of a spreadsheet is presented for display. The page layout view presents a single interface screen enabling a user to enter and revise data in a cell area of the spreadsheet, as well as manipulate a format of the spreadsheet as it will appear on a printed page. Page layout parameters such as page size, orientation, and margins are determined, and a rectangle is formed to model the page layout parameters. A border of the rectangle represents margins of the page, and an area surrounded by that border is mapped for the presentation of editable data cells. A number of cells that can be fitted in the area surrounded by the rectangle border are superimposed onto the rectangle, which is presented on a display. A plurality of rectangles representing several such pages may optionally be presented on the display at one time.

### FIELD OF THE INVENTION

The present invention generally pertains to a spreadsheet application executing on a computing system, and more specifically, to the presentation of contents of the spreadsheet on a display during execution of the spreadsheet application.

### BACKGROUND OF THE INVENTION

The explosive proliferation of the personal computer since the 1980s arguably was at least initially driven by word processing and spreadsheet applications. Both types of applications permitted users unprecedented freedom to revise their work or experiment with alternatives. For example, before computerized word processing was widely available, making even minor revisions to a document typically involved retyping entire pages of the document, if not the entire document. Experimenting with reorganizing or rephrasing portions of the document was generally viewed as unthinkable because of the work involved in recreating the document if such changes proved to be unsatisfactory.

Similarly, before spreadsheet programs were widely available, revisions in lengthy numerical analysis typically involved redoing countless arithmetical calculations. Even with a calculator, performing such calculations was time-consuming and tedious. Moreover, the possibility of a single errant keystroke might result in an error that could proliferate through many calculations. Thus, the recalculations had to be rechecked, consuming yet more time and resulting in even more tedium. In the face of such effort, changing values in a series of calculations to evaluate “what if” scenarios was impractical, if not absurd.

Fortunately, using word processing and spreadsheet applications made changing documents and spreadsheets a simple, fearless process. If an error was made or a change was desired, the correction or changes could be made and the affected page or pages easily reprinted. If more errors were found or further changes were desired, the process was simply and quickly repeated.

Improvements in personal computing technology have made these types of applications even more useful. For example, improvements in graphics and display technology have resulted in applications having “what-you-see-is-what-you-get” or WYSIWYG display capabilities, enabling users to view a document on a display screen just as the document will print on paper. In word processors, this feature was first included as a print preview function. Upon initiating a print preview function, a user briefly would exit the editing/entry screen to be able to view the document as it would print. Within the print preview function, a user could view the text, headers, footers, footnotes, page numbering, and other aspects of the document without having to print the page. Not long afterward, word processor WYSIWYG editing became available, enabling users to enter and modify text while viewing that text as it would appear in the printed document. Thus, without having to exit the editing screen, a user might view a document as it will appear when printed, and thus, could readily continue to make changes to the document to achieve a desired appearance.

Spreadsheet applications, on the other hand, have only developed some of these capabilities. Conventional spreadsheet applications do not provide WYSIWYG views of the spreadsheet while in the editing mode. Instead, spreadsheet content is created and revised on a grid bearing little resemblance to a printed page that might be generated from the application.

FIG. 1 shows a conventional data entry/editing screen 100. Screen 100 generally includes five main portions: a file name field 110, a menu bar 120, a toolbar 130, a cell area 140, and a formula bar 160. File name field 110 shows the name of the current spreadsheet file. Menu bar 120 lists headings 122 of pull-down menus, each of which provides access to a number of commands. Toolbar 130 includes icons 132 enabling direct, one-click access to a number of frequently used commands. Cell area 140 includes a plurality of cells 142 organized in a plurality of rows and columns, each cell being identifiable according to a row heading 144 and a column heading 146. Cells 142 accommodate text 148, numeric data 150, and formulas 152. For example, cell area 140 presents a spreadsheet listing profit determined by subtracting costs from income. A cell pointer 154 highlights a current cell being edited. A formula 162 stored in the current cell appears in formula bar 160, thereby enabling a user to see the formula yielding the value appearing in the current cell highlighted by cell cursor 154.

If the spreadsheet shown in FIG. 1 were to be printed, the results will appear different than what is seen in the Figure. Merely viewing cell area 140 of FIG. 1 gives a user little idea of how the printed page might appear. By selecting print preview icon 180, a user is presented with a print preview screen 200 as shown in FIG. 2A that may be generated from the spreadsheet in the cell area, but while viewing the print preview screen, the user cannot edit the content of the cells in the spreadsheet.

Print preview screen 200 generally includes a page preview area 210 and a menu bar 240. Page preview area 210 shows a representation of a full page 212 generated from the spreadsheet. Page representation 212 shows values 214 in cells 142 (FIG. 1) from cell area 140. Unlike what was shown in cell area 140, however, page representation 212 shows other information that may desirably appear on a printed page. For example, page representation 212 shows a header 216 that may describe information presented in the spreadsheet. Page representation 216 also includes a footer 218 that may include a page number 220 and other explanatory information 222 about the spreadsheet data being presented.

Page representation 212 in preview area 210 may be manipulated by choosing commands from menu bar 240, for example, to adjust the print format of the spreadsheet. Menu bar 240 includes next button 242 and previous button 244, which enable a user to page forward and back, respectively, between pages of the spreadsheet as it might be printed. A zoom button 246 enables the user to enlarge the view, if condensing the cells to a size permitting a full page to be previewed results in text too small to be reviewed satisfactorily. A print button 248 actually causes the page(s) to be printed. A setup button 250 enables a user to format the pages of the spreadsheet in ways not permitted in data entry/editing screen 100, as further described below, in connection with FIG. 2C. A margins button 254 enables a user to manipulate margins of the pages of the spreadsheet, another function not provided in the conventional data entry/editing screen 100. A page break preview button 256 enables a user to view a preview of a series of pages, to see where the page breaks fall. A close button 258 closes print preview screen 200, returning the user to data entry/editing screen 100.

Close button 258 is frequently used, because print preview screen 200 does not enable cells to be edited. A user must “flip” back and forth, exiting print preview screen 200 in order to add or change values cells in the normal editing mode, and then run the print preview again to see the results. On the other hand, print preview screen 200 is needed to adjusted parameters of pages that will be printed, which cannot be done within the editing mode. FIG. 2B shows print preview screen 200 with margin button 254 selected from menu bar 240. Selection of margin button 254 causes margin lines 260, which indicate where the margins are set at the left and right, to be superimposed over page representation 212. Margin lines 260 also indicate top and bottom margins both for data cells and header 216 and footer 218. A user can use a pointing device to drag margin lines to new locations to manipulate margin settings. Similarly, cell markers 270 mark edges of data cell widths and can be manipulated in print preview screen 200 to change the appearance of the spreadsheet as it may print. However, although margins and cell widths can be changed, the cells and their content cannot be edited in print preview screen 200.

FIG. 2C also shows print preview screen 200, but this time, with setup button 250 selected. Selection of setup button 250 opens a page setup dialog box 280 that a user must invoke to manipulate other aspects of printable pages of the spreadsheet. Page setup dialog box 280 enables a user to select tabs or buttons 282 to invoke various page formatting commands. For example, selecting a header/footer tab 284 calls up a header/footer dialog box (not shown) that enables a user to select among header and footer options, such as selectively invoking a header dialog box 286. Header dialog box 286 includes alignment ranges 290-294 in which header text 296 may be entered. In the example of page representation 212 (FIGS. 2A and 2B), header text 296 is entered in a center alignment range 292, resulting in the text of header 216 (FIGS. 2A and 2B) being center-aligned. Alternatively, entering header text in a left alignment range 290 will result in a header being left justified on the page, while entering header text in a right alignment range 294 will result in a header being right justified on the page. Buttons 298 provide other header options, such as changing header fonts, inserting the page number of the current page in the header, inserting the file name and/or file path in the header, etc. Once again, however, while headers and footers can be modified on print preview screen 200, data cells themselves cannot be added or changed.

Despite all the capabilities of print preview screen 200 to enable a user to modify overall appearance of spreadsheet pages as they will print, print preview screen does not provide the flexibility of enabling the user to modify data cells in the spreadsheet. As a result, for example, if a user is modifying the margins of spreadsheet page just before printing it and sees that a text label in a cell is inaccurate or misspelled, then the user must close print preview screen 200 and edit the text label in the cell via data entry/editing screen 100. After modifying the text label, the user may again have to enter print preview screen 200 to make sure that the change(s) made have not adversely affected the appearance of the page as it will print.

Unfortunately, creating a spreadsheet environment in which both substantive content and page format may be edited on the same screen or in the same mode is a more complicated problem than in a word processing application. Data in a word processing document is essentially one-dimensional. Changes in the one-dimensional data string, such as inserting or deleting text, may affect the end of the data string, such as by changing the page or the point in a line where the data string now ends. Nonetheless, while such changes may involve the word processing adding or deleting one or more pages, the changes in the appearance of the page when printed are relatively easily determined. On the other hand, changing a data cell in a spreadsheet can affect countless other cells in the spreadsheet that may involve one or more calculations based on the changed cell. One problem arises because the spreadsheet may contain a countless number of linkages that can be created ad hoc between cells, and changing one cell can affect many cells up, down, left, and right of the cell being changed. Sizes of cells may have to be adjusted to accommodate larger numbers. Because the spreadsheet inherently is a two-dimensional document, changing the size of a cell can change rows below and columns to the right (and thus, all the pages to right and below). An editable page view would have to account for these situations. If resolvable, it would be highly desirable to cause a spreadsheet application to enable a user to create, modify, and format a spreadsheet using a single view.

### SUMMARY OF THE INVENTION

One of the advantages of the present invention is that it provides a single view of a spreadsheet that enables a user to enter and edit data in spreadsheet cells as well as modify the formatting of spreadsheet pages. Conventional spreadsheet views enable a user to enter and/or revise contents of data in what has become considered a normal, data entry view. On the other hand, to adjust margins, create and revise headers and footers, and other formatting tasks, the user has been forced to switch to a print preview mode in which the user could not make changes to the content of data cells. In contrast, the present invention enables a user to create, revise, and format a spreadsheet—all using a single view, relieving the user of the task of switching back and forth between separate views that address substance or form, but not both.

One aspect of the present invention is thus directed to a method for displaying a page layout view of a spreadsheet application in order to present a spreadsheet as it will appear in a printable form. Page layout parameters of a printable page producible by current settings of the spreadsheet application are determined. Page layout parameters include, for example, page size, page orientation, and page margins. A rectangle is formed that incorporates the page layout parameters of the printable page. As such, the rectangle includes a rectangle perimeter representing outer dimensions of the page size, a rectangle orientation representing the page orientation, and a rectangle border within the rectangle perimeter, with the rectangle border representing the page margins. A cell area available for presenting editable data cells is then determined, where the cell area includes the area of the rectangle surrounded by the rectangle border. A number of editable data cells that can be fitted within the cell area is determined, and the cells are inserted into the cell area of the rectangle. The rectangle is then generated for display.

The present invention also provides that in a similar manner, a plurality of rectangles can be formed, where each of the plurality of rectangles represents a corresponding printable page. The plurality of rectangles formed may include a range of user-selected editable data cells or it may include all of the occupied editable data cells within the spreadsheet. A portion of the plurality of rectangles is generated for display, determined by the portion of the plurality of rectangles that can be fitted in a display area. The portion that can be fitted is determined by a zoom level of the spreadsheet application and a size of a viewing area allotted for display of the rectangles. Rectangles including adjacent cells are generated to be disposed adjacent to one another.

As a cell cursor is moved, a position of the cell cursor is monitored. A current position of the cell cursor is the current cell. A rectangle containing the current cell is identified as a current rectangle, and the current rectangle is generated for display. As the cursor is moved through the cells included in the different rectangles, it is determined if any of the cells associated with the current rectangle is associated with a position-specific object corresponding to at least one object data cell. If so, the position specific object is generated.

According to another aspect of the present invention, at least one active rectangle, including a portion of the spreadsheet to be printed, is visually distinguished from at least one inactive rectangle including a portion of the spreadsheet that is not to be printed. The visual distinction is made by making at least one visible attribute of the at least one active rectangle different from the at least one inactive rectangle. The visible attribute may include a rectangle color, such that the at least one active rectangle is presented with an active rectangle color in contrast with inactive rectangles that are presented with an inactive rectangle color.

Row and column identifiers associated with the plurality of editable data cells are preferably presented outside the rectangle perimeter, so as not to interfere with the representation of the page layout view.

Editable margin content is presented in the rectangle border. The editable margin content is positioned in the rectangle border to represent how the editable margin content will appear in a printable form. A user is permitted to edit the editable margin content upon selecting a portion of the rectangle border where the editable margin content is disposed. User input to that portion of the rectangle border is then accepted by the program. Other portions of the rectangle continue to be displayed, while the user input is accepted.

The editable margin content includes a header and/or a footer, each of which is subdivided into a plurality of ranges disposed at an alignment position. Text entered into one of the ranges is aligned corresponding to the alignment position of the alignment range.

In addition, graphical representations of page margins are presented, and a user is permitted to graphically manipulate the representations of page margins to change a size of the page margins. The size of the rectangle border representing the page margins is adjusted to reflect the changes in size of the page margins. Also, at least one ruler can be presented outside the rectangle perimeter. The ruler, that can be customized to represent units of measure in English, metric, or pixel-based units, enables a user to view a position of the page margins and/or revise the page margins relative to the ruler.

Furthermore, at least one palette for formatting may be provided to present a plurality of visible attributes assignable to portions of the rectangle. These attributes are viewable in the rectangle when one of the plurality of visible attributes is applied.

In addition, selectable display modes are preferably provided. The selectable display modes enable a user to select between the page layout view and a cell-based view. The cell-based view is configured to display the editable data cells and suppress the page layout parameters. A view selector is provided to enable a user to choose either the page layout view or the cell-based view by selecting a representative icon for the desired view.

### BRIEF DESCRIPTION OF THE DRAWING FIGURES

The foregoing aspects and many of the attendant advantages of this invention will become more readily appreciated as the same becomes better understood by reference to the following detailed description, when taken in conjunction with the accompanying drawings, wherein:

FIG. 1 (Prior Art) is a screen view of a conventional spreadsheet application in a data entry/editing mode;

FIG. 2A (Prior Art) is a screen view of a conventional spreadsheet application in a print preview mode;

FIG. 2B (Prior Art) is a screen view of a conventional spreadsheet application in a print preview mode, enabling margins to be adjusted;

FIG. 2C (Prior Art) is a screen view of a conventional spreadsheet application in print preview mode, presenting a dialog box by which a user can edit headers and footers;

FIG. 3 is a screen view of a spreadsheet application in a page layout view mode according to an embodiment of the present invention;

FIGS. 4A and 4B are screen views of the page layout view mode showing changes to format of displayed pages being made using a formatting palette;

FIGS. 5A and 5B are screen views of the page layout view showing the margins being changed;

FIG. 6 is a screen view of the page layout view mode showing the header being edited;

FIG. 7 is a flow diagram illustrating the logical steps for forming rectangles representing pages displayable in the page layout view;

FIG. 8 is a flow diagram illustrating the logical steps for generating the rectangles representing pages for display in the page layout view;

FIG. 9 is a flow diagram illustrating the logical steps for directing display of the page layout view in response to a user editing headers and footers;

FIG. 10 is a flow diagram illustrating the logical steps for directing display of the page layout view during scrolling of the spreadsheet; and

FIG. 11 is a functional block diagram of a generally conventional computing device or personal computer (PC) that is suitable for executing a spreadsheet application as used in practicing the present invention.

### DESCRIPTION OF THE PREFERRED EMBODIMENT

Representative Spreadsheet Screen in a Page Layout View

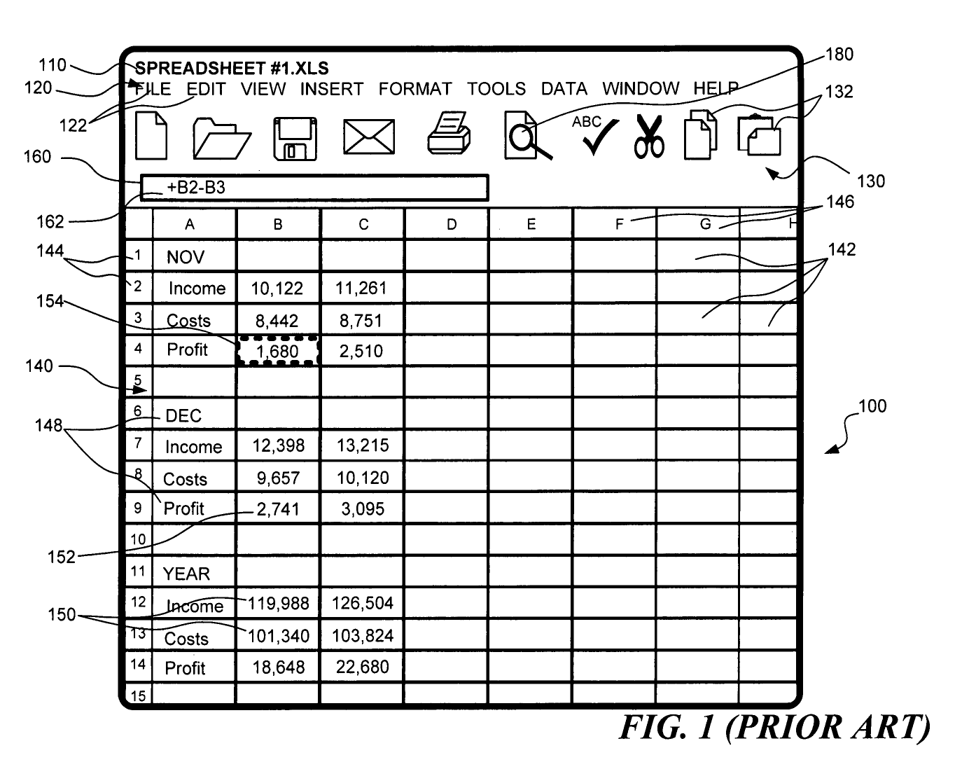

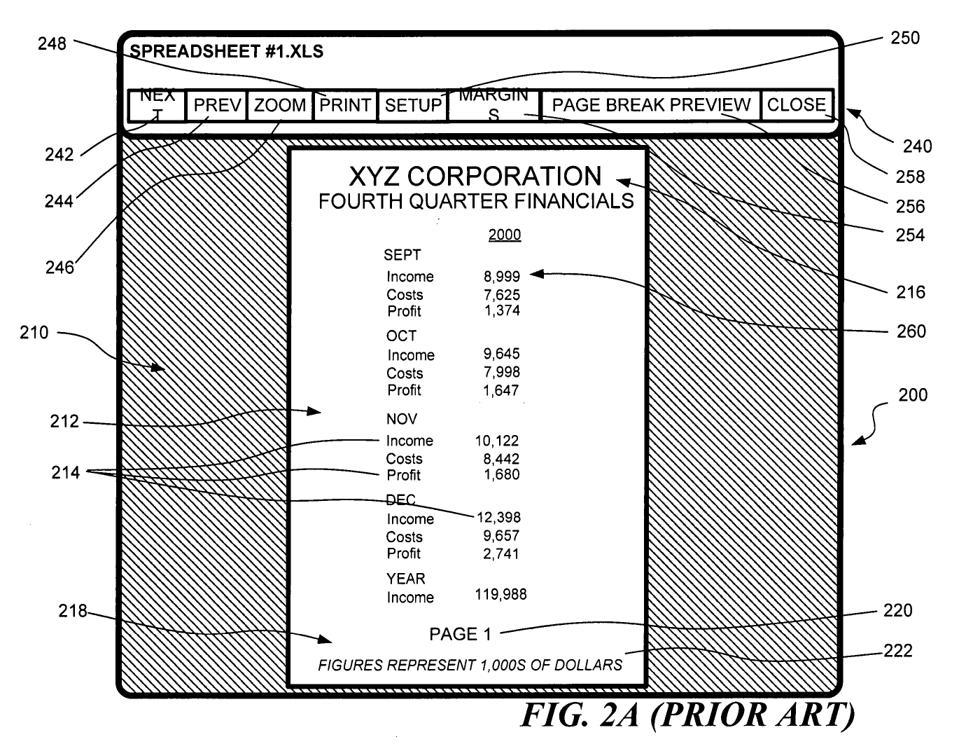

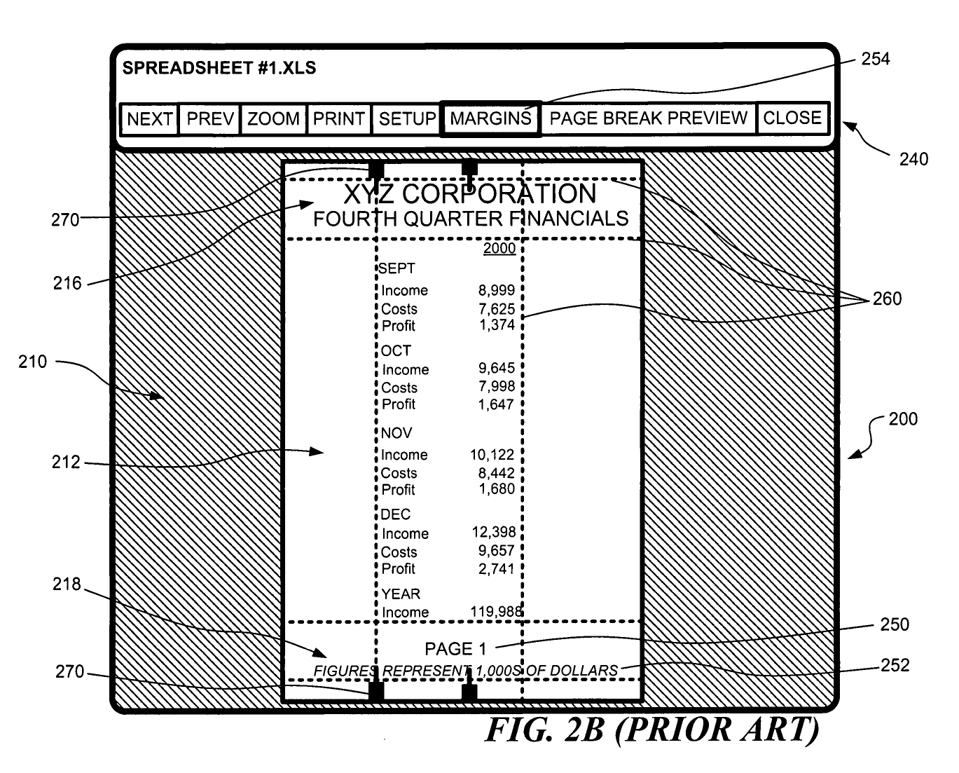

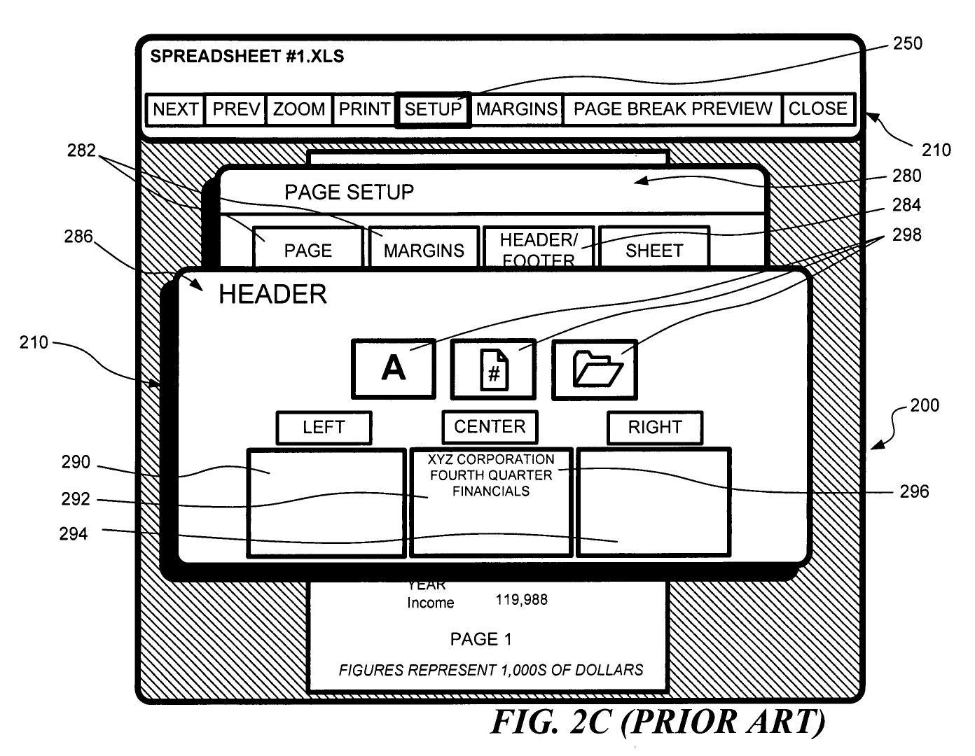

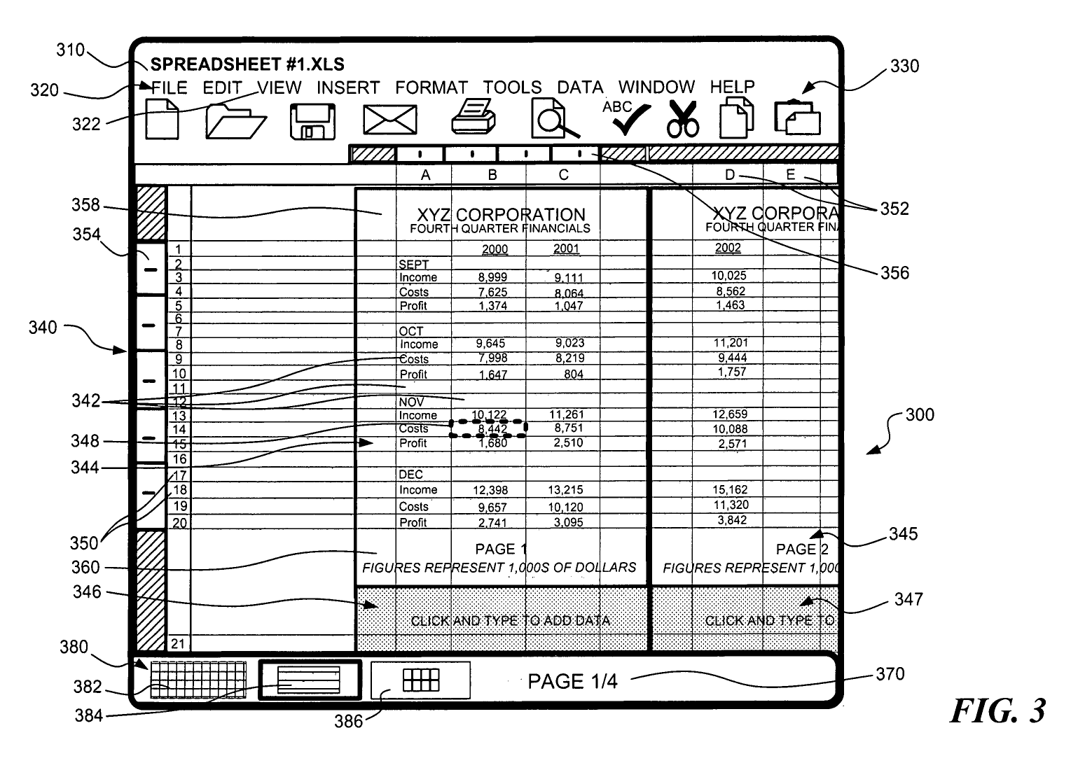

FIG. 3 is a page layout view screen view 300 displaying a spreadsheet according to an embodiment of the present invention. Page layout view screen 300 generally includes five main portions: a file name field 310, a menu bar 320, a toolbar 330, and a page area 340. A formula bar (not shown), comparable to formula bar 160 (FIG. 1) may be included to display formulas associated with cells 342 in the spreadsheet. As will be understood by those familiar with spreadsheet programs and other graphical user interface based programs, toolbars such as the formula bar typically can be toggled via a view option 322 on menu bar 320. In one embodiment of the present invention, view option 322 also enables a user to select page layout view screen 300 or other views, such as a conventional data entry/editing view screen, as shown in FIG. 1 or a conventional print preview screen as shown in FIG. 2A.

Page area 340 displays at least one page of a spreadsheet as it would appear when printed. Page area 340 shows active pages 344-345, as well as portions of inactive pages 346-347. Active pages 344-345 include pages that will be printed. Pages are active pages when they encompass cells selected for printing. Active pages 344-345 are made to visually stand out relative to inactive pages 346-347. As shown in FIG. 3, for example, active pages 344-345 are indicated using an active page background color, such as paper white. By contrast, inactive pages 346-347 are shown using an inactive page background color, such as a shade of gray. Presence of cell cursor 348 indicates to a user which page and cell currently are selected for data entry or editing. A page indicator 370 informs the reader which page of a multiple page spreadsheet currently is selected for data entry or editing.

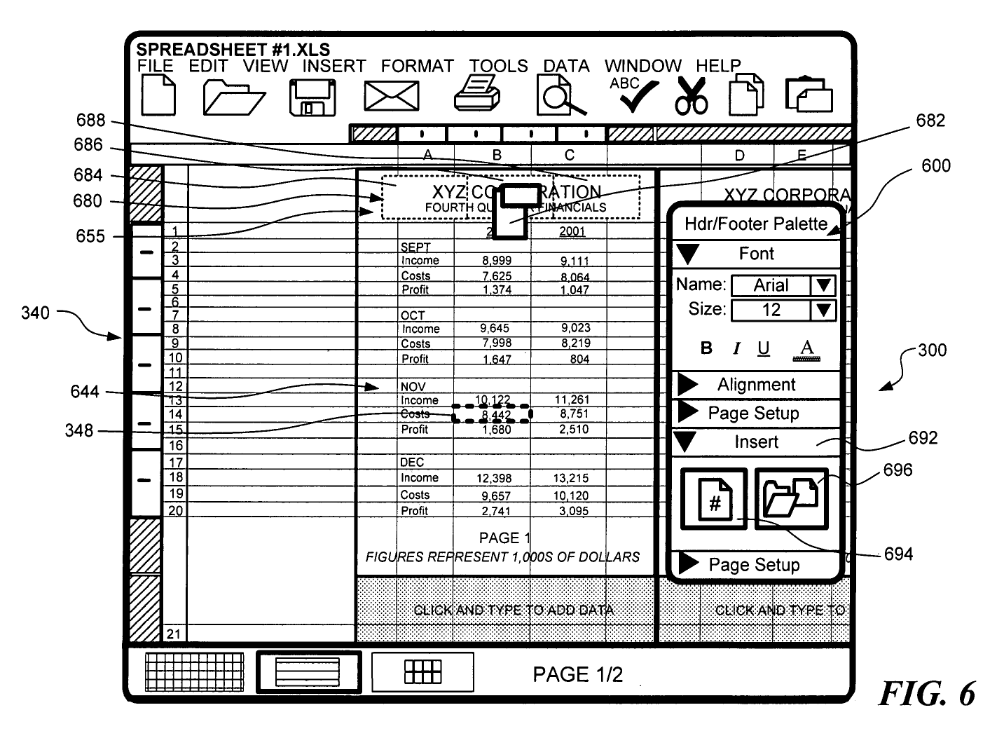

In one embodiment of the present invention, for all of the pages displayed in the page area 340 including active pages 344-345 and inactive pages 346-347, row headings 350 and column headings 352 identify coordinates of cells 342. Also, a vertical ruler 354 and a horizontal ruler 356 are presented around two sides of a current, active page 344 to provide a user with a visual reference as to where the contents of the current, active page 344 are positioned. The current page is that page where cell cursor 348 is located, indicating which cell of which page is currently selected for data entry or data editing. Embodiments of the invention are configured to generate the current page for display so that the user can see changes the user may make to the spreadsheet. Rulers 354 and 356 also enable margins on displayed pages 344-345 and inactive pages 346-347 to be changed, as further described below in connection with FIGS. 6A and 6B. The rulers can be customized to represent units of measure in English, metric, or pixel-based units.

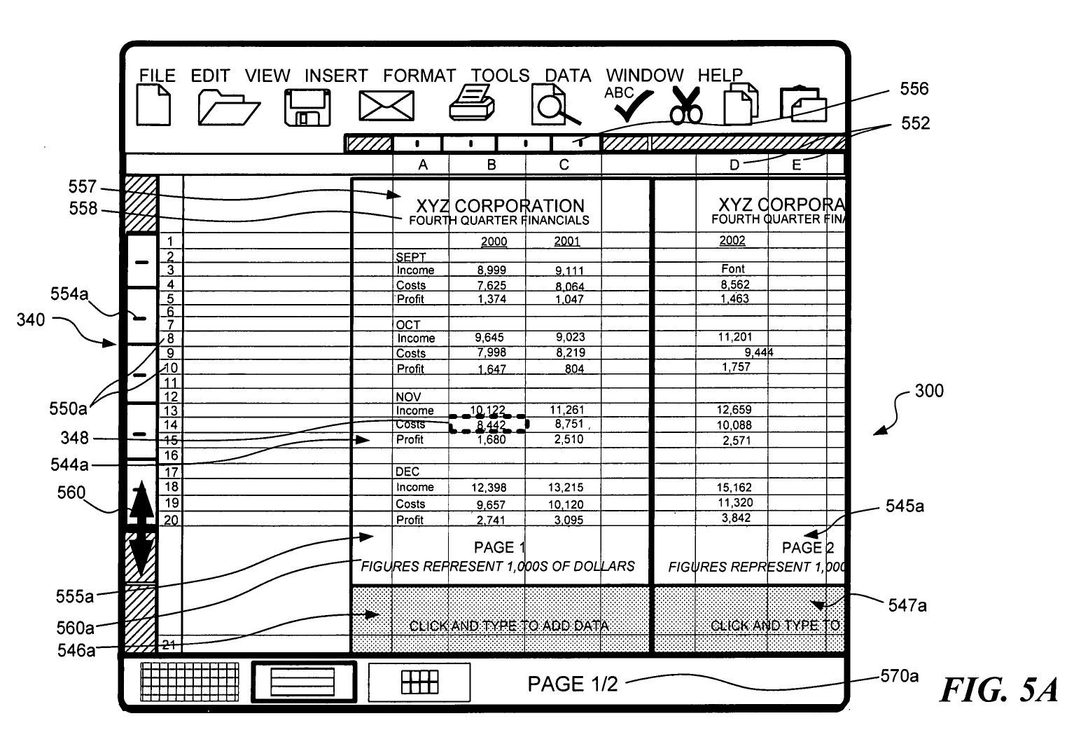

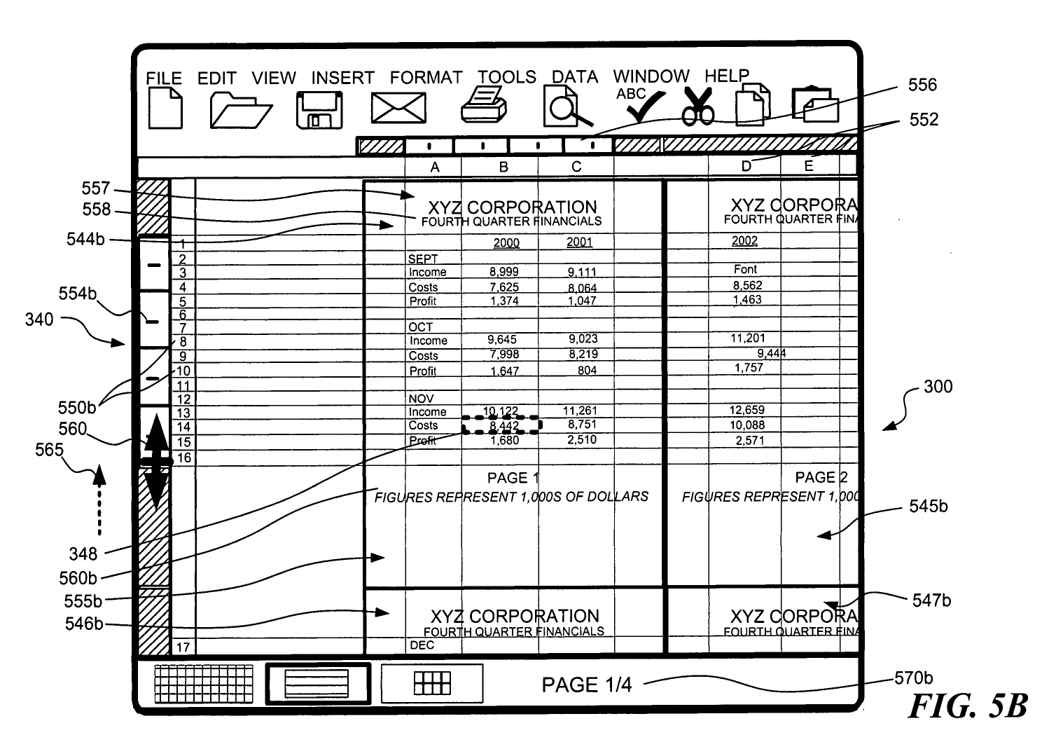

A header 358 and a footer 360 are also displayed in page layout view screen 300. Thus, a user can see header 358 and footer 360 while editing cells 342 and, as described further below in connection with FIG. 5, can edit header 358 and footer 360 while still able to see the content of cells 342 on the page. As was shown in FIG. 2C, entering or revising a header or footer in a conventional print preview screen not only did not enable cells to be edited in that same screen, but the dialog box obscured the content of cells on the page while the editing is being performed.

In a preferred embodiment of the present invention, a user is permitted the option of entering and revising data in cells 342 using a conventional grid, as well as using page layout view screen 300. In one embodiment of the present invention, a user can select between views by making a selection from menu bar 320. Also, a user is presented with a view selector 380. View selector 380 permits a user to select an icon, such as conventional grid icon 382, page layout icon 384, or page break preview icon 386, to select how the spreadsheet is displayed. In one embodiment of the present invention, page layout screen 300 is set as a default view for creating and editing spreadsheets. However, a user can change the view and/or change the default view, as desired.

From FIG. 3, it is apparent that page layout view screen 300 offers a number of advantages over conventional spreadsheet data entry/editing and print previews. As compared to the conventional data entry/editing screen of FIG. 1, which included an undifferentiated array of cells, page layout view 300 presents the cells in differentiated pages so that a user can see how a printed version of the spreadsheet will appear, including the content of the cells, the margins, the header, and the footer. Moreover, the user not only can see all the content of the page that will be presented on a printed page, but can also create and/or edit each portion of the spreadsheet without switching to another view.

Changes in Page Format Manifested in Page Layout View

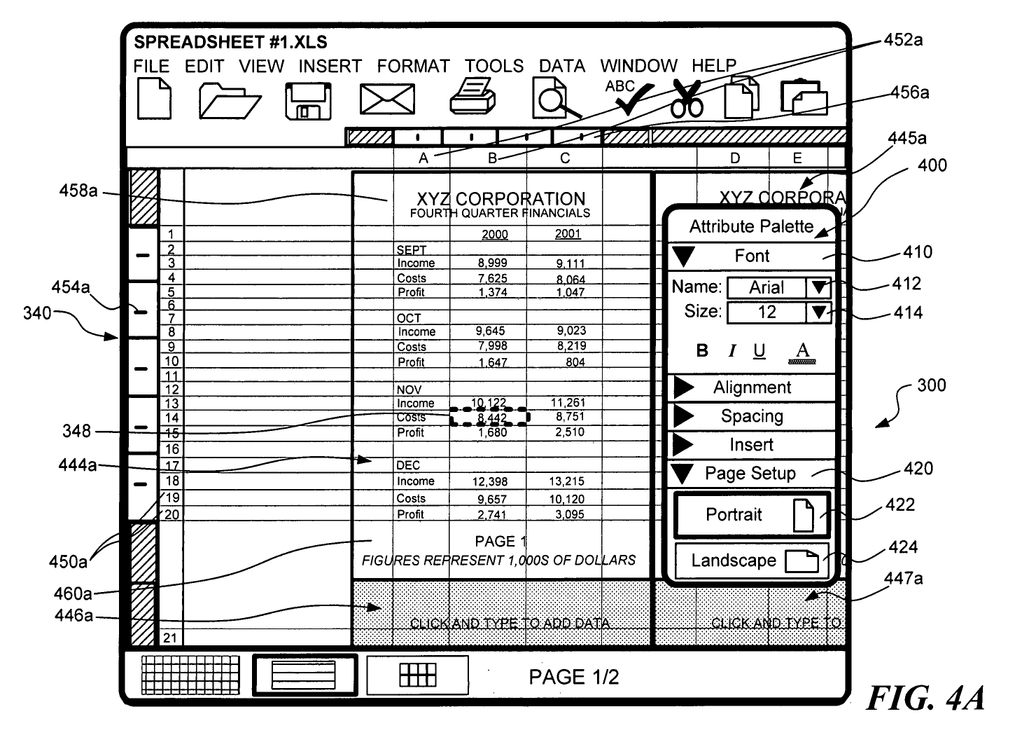

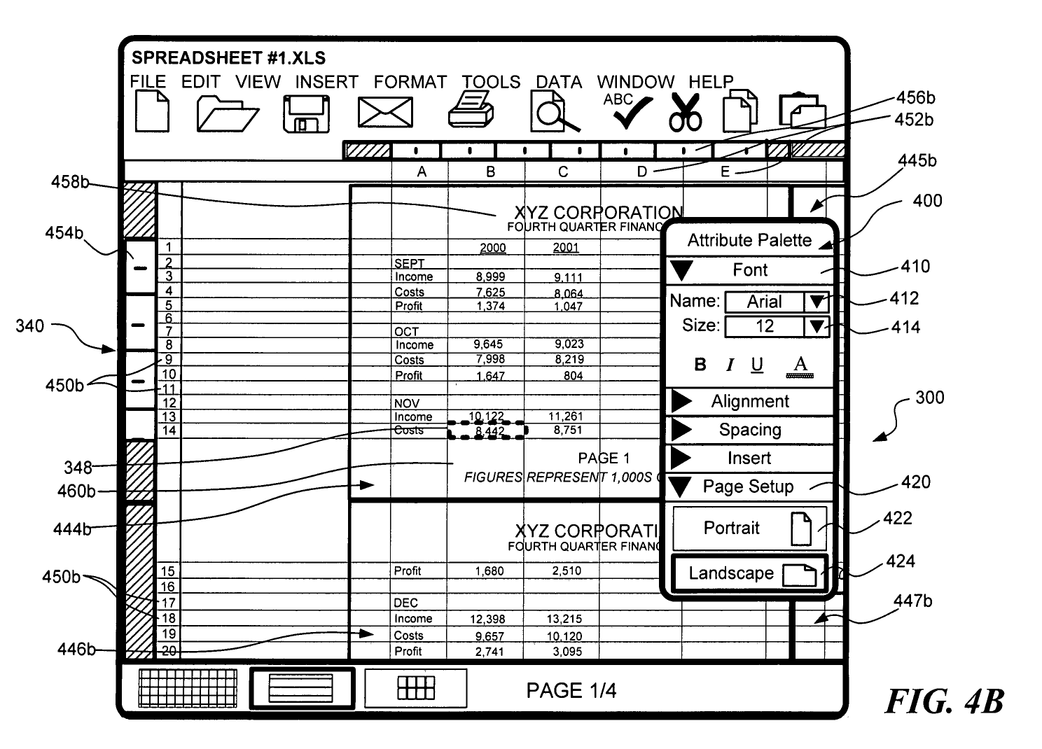

FIGS. 4A and 4B show other advantages of page layout view screen 300. In particular, FIGS. 4A and 4B shows an attribute palette 400 that can be invoked by a user to make changes in the appearance of the spreadsheet while the user is able to see the effect of those changes in page layout view screen 300. Again, unlike conventional spreadsheet programs, a user can make and view spreadsheet formatting changes without switching to another view. Attribute palette 400 includes some options currently available in a data entry/editing screen, such as a font change option 410. However, attribute palette 400 in page layout view screen 300 also includes options, such as page setup option 420, enabling a user to make changes between a portrait mode 422 and a landscape mode 424. In FIG. 4A, page setup option 420 shows that portrait mode 422 is the currently selected mode. As a result, in FIG. 4A, current active page 444a-445a and inactive pages 446a-447a are shown in page area 310 of page layout view screen 300 as upright, portrait style pages. However, in FIG. 4B, the user has selected landscape mode 424 as page setup option 420, resulting in a number of changes to the display.

In shifting to the landscape mode shown in FIG. 4B, a number of active pages has changed. In switching to landscape mode, a number of rows that may be fit onto a single page, such as page 444b, has been reduced. As a result, rows including cells in which data has been entered now are pushed onto previously inactive pages 446b and 447b. The shading of now-active pages 446b-447b is changed to indicate that now pages 444b-445b and pages 446b-447b all are active. Also consistent with the change in page orientation, the number of rows and corresponding row headings 450a on active pages 444a-445a decreases to the number of rows and corresponding row headings 450b shown on active pages 444b-445b in landscape mode. Correspondingly, the number of columns and column headings 452a on active pages 444a-445a increases to the number of columns and column headings 452b shown on active page 444b-445b. In addition, margins are reshaped, as reflected in the displayed margins, vertical ruler 454a shortens to become a vertical ruler 454b, and horizontal ruler 456a lengthens to become a horizontal ruler 456b. Furthermore, header 458a and footer 460a, which are center-justified, are shifted laterally relative to a header 458b and a footer 460b, consistent with the change in page layout.

All of these changes are implemented and displayed in the page layout view screen 300, while still enabling a user to edit cells, such as a current cell marked by cell cursor 348. The user can change both the content and formatting of the spreadsheet using only the page layout view screen 300 without having to switch to a different view or mode.

FIGS. 5A and 5B are screen views of page layout view 300 showing that the margins can be changed by user manipulation of the vertical and horizontal rulers. As shown in FIGURE SA, to change margins of displayed pages 544a, 545a, 546a, and 547a, the user employs a pointing device to select an end of a ruler, just as a user might do currently in a print preview view for a conventional spreadsheet application. More particularly, in FIG. 5A, the user selects a bottom end of vertical ruler 554a to effect a change in the size of a bottom margin area 555a. Selecting the end of vertical ruler 554a results in the shape of the cursor changing from a general, pointed cursor, to an appropriately-shaped formatting cursor 560. To change the bottom margin position, as shown in FIG. 5B, the user directs formatting cursor 560 in the direction of an arrow 565 (or in the opposite direction), as desired.

As shown in FIG. 5B, moving formatting cursor 560 in the direction of arrow 565 enlarges bottom margin area 555a, resulting in a bottom margin area 555b. This change in the margin position results in a number of other changes, including footer 560a moving upward, as indicated by a footer 560b to maintain its relative position in bottom margin area 555b. Vertical ruler 554a shortens in length, becoming a vertical ruler 554b, which corresponds with the shortened vertical dimensions of the main portion of the active page as thus changed. Also, the number of rows and row headings 550a that can be fitted on pagse 544a-545a is reduced to the number of rows and row headings 550b that can be fitted on pagse 544b-545b. With a fewer number of rows that can be fitted on each page, the total number of active pages used to encompass active cells expands to include pages 544b, 545b, 546b, and 547b. The shading of pages 546b and 547b is changed to indicate that these now are active pages. In addition, a total number of active pages needed to display all the active cells, including pages not displayed in page area 340, may increase from, for example, two pages to four pages. The change in the total number of active pages is reflected by the change in a page indicator 570a to a page indicator 570b. However, unlike the change in page layout from portrait mode to landscape mode described in regard to FIGS. 4A and 4B, top margins 557 and header 558 do not change, nor does the number of columns and column headings 552 that can be fitted on each page change.

It must be stressed that these formatting changes are implemented and displayed in the page layout view screen 300, in which cells and their contents can be edited. Again, cell cursor 348 remains present indicating the cell that is currently selected for data entry or revision. The user can change both the content and formatting of the spreadsheet using only the page layout view screen 300 without having to switch to other page views.

Embodiments of the present invention also permit a user to edit the content of headers or footers in page layout view screen 300. As a result, the user need not switch to a different view to modify headers or footers. Moreover, the user can edit headers and footers as they appear on the displayed pages instead of having to use a dialog box. Thus, the user can directly see how the changes will appear on the printed page.

In FIG. 6, in page layout view screen 300, the user has moved the cursor over a top margin area 655 of an active page 644 and into a header region 680. In one embodiment of the present invention, header region 680 is disposed in top margin area 655. Moving a cursor over header region 680 results in a header-specific cursor 682 being displayed, indicating that user can now edit the header. Upon selecting header region 680, the header region is visually divided into alignment ranges. More specifically, in the embodiment of the invention illustrated in FIG. 6, header region 680 is divided into a left alignment range 684, a center alignment range 686, and a right alignment range 688. In selecting the region in which to enter text, the user indicates how the header is to be aligned, as was the case with header dialog box 286 described in connection with FIG. 2C. It will be appreciated that footer editing is carried out in a fashion similar to header editing.

FIG. 6 also shows a header/footer attribute palette 600 that is usable header and footer formatting. For example, if a-user wishes to insert the number of the current page of the spreadsheet file, the user can position the cursor in alignment range 684-688 where the user wants the page number to appear, then select page number icon 694 from an insert area 692 of header/footer palette 600. Similarly, if the user wishes to insert the file path in the header or footer, the user can do so by positioning the cursor in alignment range 684-688 where the user wants the file path to appear, and then selecting a file path icon 696 from header/footer palette 600. Again, as is the case with other aspects of the page layout view screen, the result of the formatting operation is presented on the display so that the user can see how the selection will appear on a printed page of the spreadsheet without having to switch to a different view. It will be appreciated that functions associated with header/footer palette 600 may be implemented using a plurality of separate palettes instead of a single palette. For example, a separate page numbering toolbar or palette may be used to insert or modify page numbers, rather than including such a function in the formatting palette.

Once again, it should be noted that the header/footer editing and formatting is supported by page layout view screen 300, while enabling the contents of cells to be edited without changing view or mode. Cell cursor 348 indicates that cells and their contents are editable in page layout view screen 300 at the user's option.

Presenting a Spreadsheet in Page Layout View

According to an embodiment of the present invention, page layout view is generated by forming rectangles sized to model the size and disposition of page(s) of the spreadsheet. Superimposed on these rectangles are borders modeling the margins of the page(s). Cells of the spreadsheet then are presented in the rectangles in the area surrounded by the borders. Generally, presenting the contents of the cells, as well as the storage and any relevant mathematical manipulations applied to the cells, is handled using routines like those that are used for conventional data entry/editing screens. A difference is that, instead of setting an entire display area as the pane used by the cell-generating routines, the pane is set equal to each of the areas of the rectangles surrounded by the rectangle borders. The present invention does not change the underlying structure of how spreadsheets are calculated and stored, but does reformat the display of editable data in a form enabling a user to view how data or formatting being entered or revised affects printable pages that will be generated by the spreadsheet.

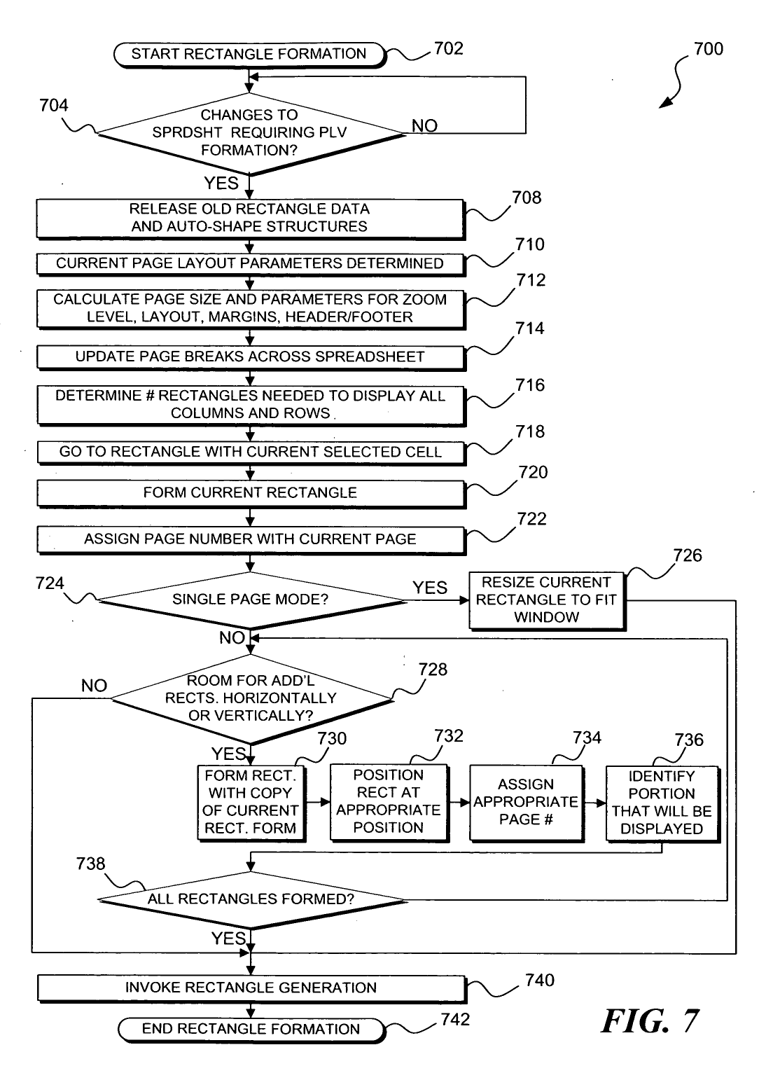

FIG. 7 is a flow diagram 700 illustrating the logical steps for creating rectangles representing pages displayable in the page layout view. Flow diagram 700 begins at a step 702. At a decision step 704, it is determined if changes to the spreadsheet have been made that will require recreation of the page layout view. Not all changes to the spreadsheet require reformation of the page layout view. For example, if a user enters or revises data in cells that currently can be accommodated in the page layout view screen without reformatting the page, adding a page, etc., the cell presentation routine can log and display those changes without the page layout view having to be reformed. Accordingly, if it is determined at decision step 704 that the page layout view does not require reformation, flow diagram 700 loops to decision step 704 until a change is made involving reformation of the page layout view.

On the other hand, when a change is detected requiring reformation of the page layout view, the flow diagram proceeds to a step 708, where old rectangle and auto shape data structures are released. If the page layout view and its associated rectangles are to be reformed, the old data defining formats of the rectangles are no longer needed, and the data are released. Similarly, auto-shape data, which are data defining a shape attached to a particular cell of a spreadsheet, may be moved or eliminated by the user action causing step 708 to be invoked. Auto-shapes and similar objects are reformed as needed, when the associated cell is displayed. In one embodiment of the invention, as rectangles are being reformed, the auto-shapes and similar objects are released. After the rectangles are reformed, auto-shapes and similar objects are regenerated when the associated cell with which the auto-shapes/objects are associated, is being displayed.

At a step 710, current page layout parameters, including any changes just made by the user, are determined. At a step 712, page size, page layout, zoom level, margins, header and footer sizes, and other attributes that determine the size, orientation, and other aspects of the rectangle, such as how much space is available for cells to be displayed on each page, are determined. Based on this information, at a step 714, page breaks that fall between rows and/or columns of cells in the spreadsheet are updated. More specifically, the page breaks determine the cells that are associated with each rectangle, subsequently resulting in those cells being presented on that rectangle, which represents a page that will accommodate those cells. At a step 716, it is determined how many rectangles are needed to display the cells. The number of cells to be displayed may include all occupied cells in the spreadsheet, or a selected subset of this number of cells.

At a step 718, flow diagram 700 moves to a current rectangle that will represent the page with the currently selected cell. At a step 722, a page number associable with the current rectangle is determined. Using this page number, together with the total number or rectangles needed to display all relevant pages determined at step 716, a page number/total number of pages indicator is presented to a user, as shown in FIG. 3.

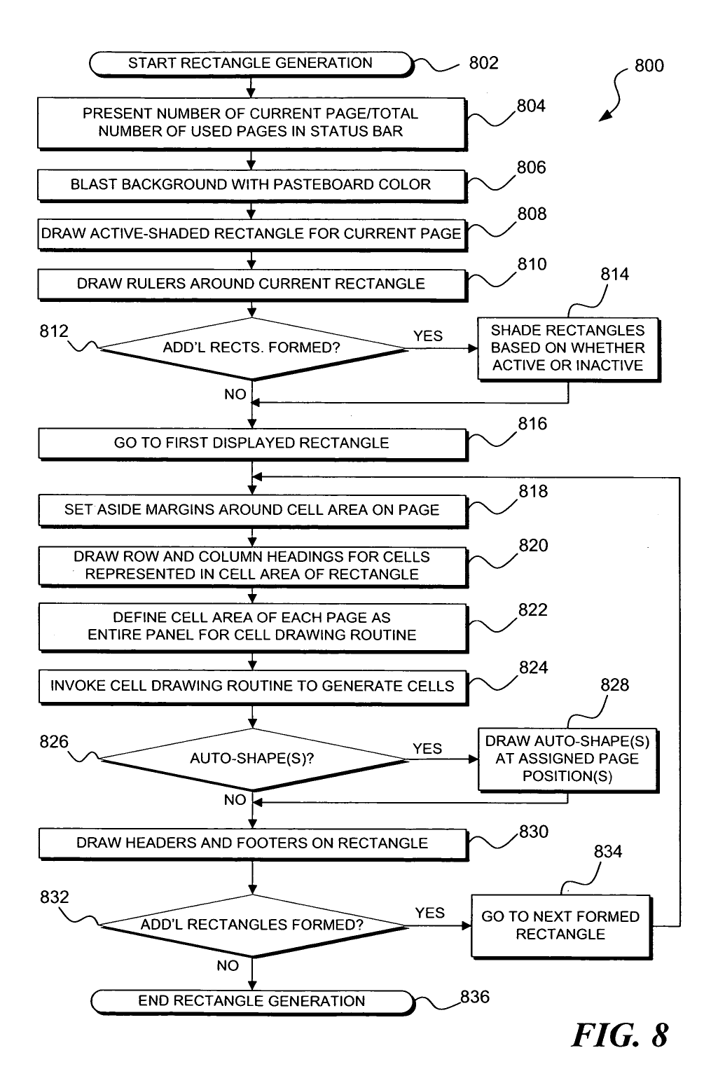

At a decision step 724, it is determined if the application is executing in a single page mode. If so, at a step 726, the rectangle is resized to fit the cell display area window, preferably while maintaining an aspect ratio corresponding to the paper size included in the page layout parameters determined at step 710. Because only one rectangle need be formed in single page mode, the flow diagram proceeds from step 726 to a step 740, where rectangle display generation is invoked, as further described below, in connection with FIG. 8. On the other hand, if it is determined at decision step 724 that the application is not executing in single page mode, flow diagram proceeds to a decision step 728 to determine if, at current parameter settings, room is available to display additional page-representing rectangles on the display alongside the current rectangle representing a page containing the current cell. If it is determined that there is no room to display other rectangles, the flow diagram proceeds to step 740 to invoke the rectangle display generation.

On the other hand, if it is determined at decision step 728 that there is room to display other rectangles, at a step 730, another rectangle is formed, using the same attributes as the current rectangle. At a step 732, the new rectangle is positioned at an appropriate position where there is room for additional rectangles, based on current page layout attributes, whether to the top, bottom, left, and/or right of the current rectangle. Where the rectangle is positioned is a function of the coordinates of the cells the rectangle includes relative to the coordinates of the cells accommodated by the current rectangle. At a step 734, a page number of the new rectangle is determined and assigned. At a step 736, it is determined if all of the rectangle will be displayed, or only a portion of the rectangle, based on the current page layout parameters and available space determined at step 728. At a decision step 738, it is determined if all rectangles have been formed. If not, flow diagram 700 loops to decision step 728 to determine if there is room for additional rectangles to be displayed. On the other hand, if it is determined that all of the rectangles have been formed, the flow diagram proceeds to step 740 to invoke the rectangle generation routine. Once the rectangle generation routine is invoked, the flow diagram ends at a step 742.

FIG. 8 includes a flow diagram 800 illustrating the logical steps for generating the rectangles representing pages for display in the page layout view. Flow diagram 800 begins at a step 802. At a step 804, a page number of the current page and the total number of pages determined in flow diagram 700 are presented as a page number indicator, such as page indicator 370, as shown in FIG. 3. At a step 806, a display background is colored or “blasted” with a background or pasteboard color to provide a background for the displayed page or pages. At a step 808, for the current page, a white rectangle is drawn. At a step 810, rulers are generated around one or two sides of the current page. At a decision step 812, it is determined if additional rectangles were formed in accordance with flow diagram 700. In one embodiment of the invention, as previously described, the rectangles representing active pages are colored or shaded differently to make them stand out from inactive pages. If so, at a step 814, active rectangles including cells that are to be printed are presented in an active rectangle color, while inactive rectangles that do not include cells to be printed are presented in an inactive rectangle color.

Once the rectangle or rectangle(s) have been drawn, at step 816 flow diagram 800 sets itself to the first displayed rectangle. At step 818, a border is drawn within the rectangle to set aside the margins around the cell area on the rectangle representing each page. At step 820, row and column headings are drawn for cells that will be represent in the cell area of the rectangle. At step 822, the cell area remaining is defined as the pane for the cell drawing routine. At step 824, the cell drawing routine is invoked. At decision step 826, it is determined if there are auto-shapes or other cell-specific objects in among the cells in the cell area. If so, at step 828, the auto-shapes or other objects are generated and, if indicated by shape parameters, positioned in the rectangle according to the position of the cell with which the object is associated. If it is determined that there are no auto-shapes or once the auto-shapes have been generated, at a step 830, headers and footers, if any, are drawn in each of the rectangles in the appropriate portion of the rectangle border for the top and bottom page margin area.

At a decision step 832, it is determined if additional rectangles were formed by flow diagram 700. If so, at a step 834, flow diagram 800 receives data describing the next formed rectangle, and the flow diagram loops to step 818 to commence drawing the next rectangle. On the other hand, if it is determined at decision step 832 that all the rectangles have been generated, flow diagram 800 ends at a step 836.

Editing Header/Footer in Page Layout View

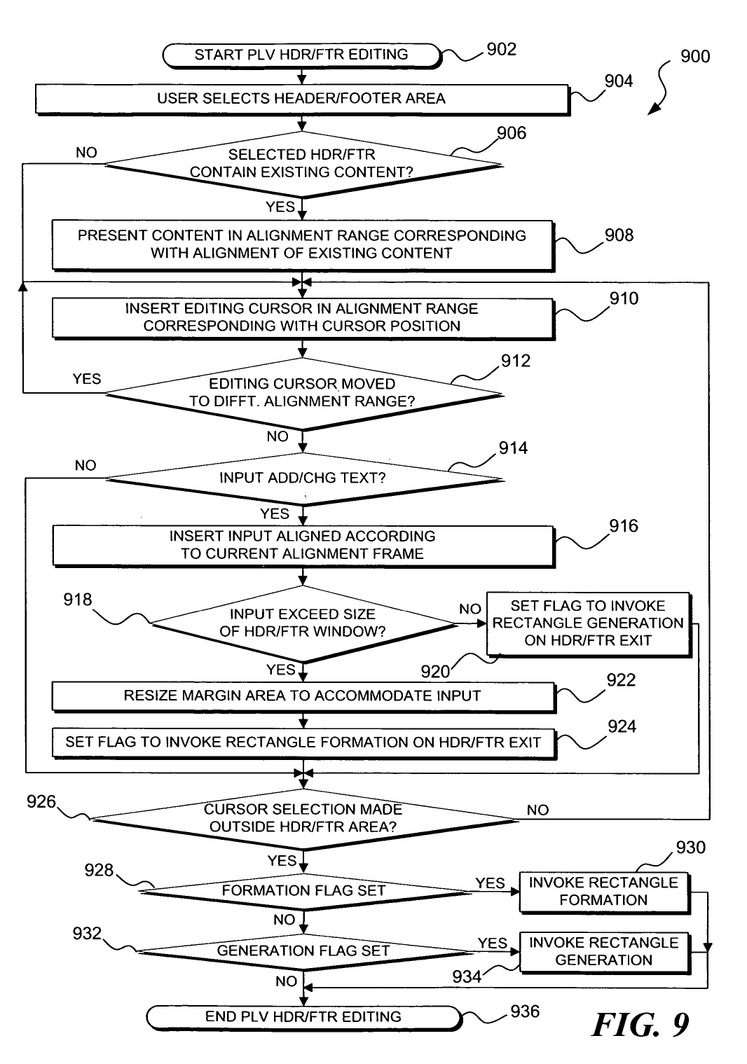

As described above, one of the advantages of the present invention is the ability to edit headers and footers directly in the page layout view, without using a dialog box. This process enables a user to see how the headers and footers look on the page and/or how the headers and footers may affect the rest of the page layout without having to switch back and forth between views/modes. FIG. 9 shows a flow diagram 900 illustrating the logical steps for display of the page layout view in response to a user editing headers and footers.

Flow diagram 900 begins at a step 902. At a step 904, the user selects a header or footer area in a rectangle border. At a decision step 906, it is determined if the selected header or footer already includes existing content. If so, at a step 908, the existing content is presented in the alignment range corresponding to the current alignment of the content. Thus, for example, if the header is center-justified, as in the preceding examples, the header content is presented in the center alignment range. If it is determined that there is no existing header or footer content or that the content has been displayed, at a step 910, an editing cursor is inserted in the alignment range in which the cursor was positioned when user selected the header or footer.

At a decision step 912, it is determined if the user has moved the cursor to a different alignment range, which might occur if the user has mistakenly selected one alignment range over another or the user decides to select a different alignment range. If so, flow diagram 900 loops to step 910 and repositions the editing cursor. If not, flow diagram 900 proceeds to a decision step 914 to determine if input was made to add text or change existing text. Input can be in the form of keystrokes or selecting an insertion option, as described above, in connection with FIG. 6. If it is determined that no input has been entered, flow diagram 900 proceeds to a step 926 that leads to exit of the header/footer editing routine. It will be appreciated that, if no input was made, the rectangle including the header or footer does not need to be reformed or regenerated for display.

On the other hand, if it is determined that input has been entered, at a step 916, the input is entered into the alignment range that was selected when the input was entered. At a decision step 918, it is determined if the input to the header or footer block exceeds the size allotted for the current margin. If not, at a step 920, a flag is set to invoke the rectangle generation. If the text does not cause the header or footer to exceed the allotted margin space, the input can be entered merely by regenerating the rectangles without having to reform the rectangles. On the other hand, if the input exceeds the allotted margin space, flow diagram 900 proceeds to a step 922, where the margin is resized to accommodate the input. Next, at a step 924, a flag is set to invoke the rectangle formation. It will be appreciated that, if the size of the header or footer exceeds the space that was allotted to it, margins will have to be resized. In turn, the number of rows that can be fitted on pages represented by the rectangles will decrease. Thus, page breaks will shift, and the rectangles will need to be regenerated.

At a decision step 926, it is determined if a cursor selection has been made outside the header or footer area. If not, flow diagram 900 loops to step 910 to enable the user to continue editing headers and footers. On the other hand, if it is determined that a selection has been made outside the header or footer area, flow diagram 900 begins its exit process. At a decision step 928, it is determined if the rectangle formation flag was set at step 924. If so, at a step 930, flow diagram 900 invokes the rectangle formation and ends at a step 936. If the rectangle formation flag was not set, at a decision step 932, it is determined if the rectangle generation flag was set. If so, at a step 934, the rectangle generation is invoked, and the flow diagram ends at step 936. It will be appreciated that, if rectangle formation was invoked at step 930, the rectangle formation routine 700 (FIG. 7) will invoke the rectangle generation.

Scrolling in Page Layout View

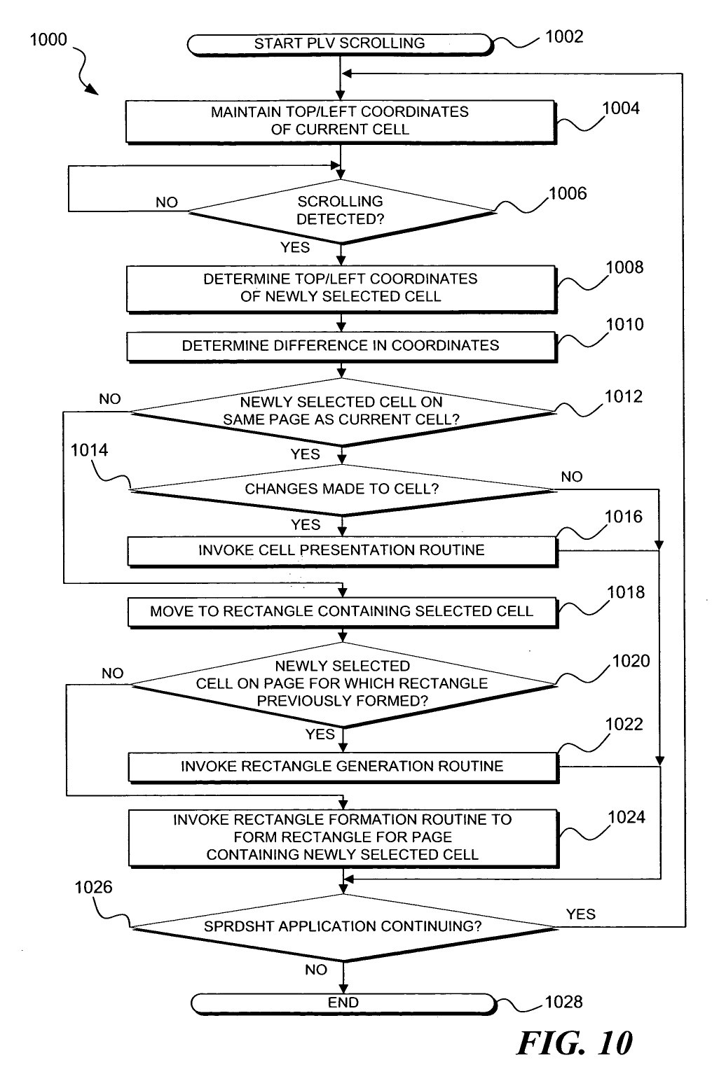

FIG. 10 includes a flow diagram 1000 illustrating the logical steps for directing display of the page layout view when the spreadsheet is scrolled. The spreadsheet will be scrolled when, for example, a page to be displayed on the screen is changed as a result of a user scrolling or paging down through the spreadsheet, or another function is performed that necessitates display of a different page on the screen. By contrast, a user repositioning the cell cursor at another cell in a currently displayed page does not cause the spreadsheet to be scrolled. On the other hand, scrolling to a page not currently displayed will involve scrolling the spreadsheet. The present invention accounts for such user actions.

Flow diagram 1000 begins at a step 1002. At a step 1004, the top/left coordinates of the currently selected-cell are maintained as a point of reference. At a decision step 1006, it is determined if scrolling, that, for example, might be caused by the user manipulating scroll bars or otherwise paging up, down, or across the spreadsheet has been detected. If not, flow diagram 1000 loops to step 1006 to await scrolling. On the other hand, if it is determined at decision step 1006 that cursor movement has been detected, at a step 1008, top/left coordinates of the newly selected cell are determined, then, at a step 1010, a difference in coordinates between the original coordinates noted at step 1004 and the new coordinates determined at step 1008 is calculated. At a decision step 1012, it is determined if the newly selected cell is on the same page as the current cell. If so, rectangles need not be regenerated and/or formed. The flow diagram proceeds to a decision step 1014, where it is determined if changes have been made to the selected cell which, in turn, may result in changes to other cells on the displayed page if those other cells, for example, depend on a value or result of a formula stored in the current cell. If not, flow diagram 1000 proceeds to decision step 1026 to determine if the application execution is continuing. On the other hand, if it is determined at decision step 1014 that changes have been made to the cell, at a step 1016, the cell presentation routine is invoked. As described above, when rectangles need not be changed, conventional cell handling routines can process any changes made in the cells. Once the cell presentation routine has been invoked and processed at step 1016, flow diagram 1000 proceeds to decision step 1026 to determine if the application execution is continuing.

Conversely, at decision step 1012, if it is determined that the newly selected cell is not on the same page as the current cell, at a step 1018, execution moves to the rectangle where the newly selected cell is located. At a decision step 1020, it is determined if the newly selected cell is located in a rectangle that has already been formed. If so, at a step 1022, the rectangle generation routine is invoked to generate the rectangle for display. On the other hand, if it is determined at decision step 1020 that no rectangle including the selected cell has been formed, e.g., if the cell is in a previously unused part of the spreadsheet, at a step 1024, the rectangle creation routine is invoked.

If at decision step 1026, it is determined that the spreadsheet application execution is continuing, routine 1000 loops to step 1004 to store coordinates of the current cell and await any cell cursor movement. On the other hand, if it is determined that the application execution has ceased, scrolling/data entry processing ceases at a step 1028.

Exemplary Computing System for Implementing Present Invention

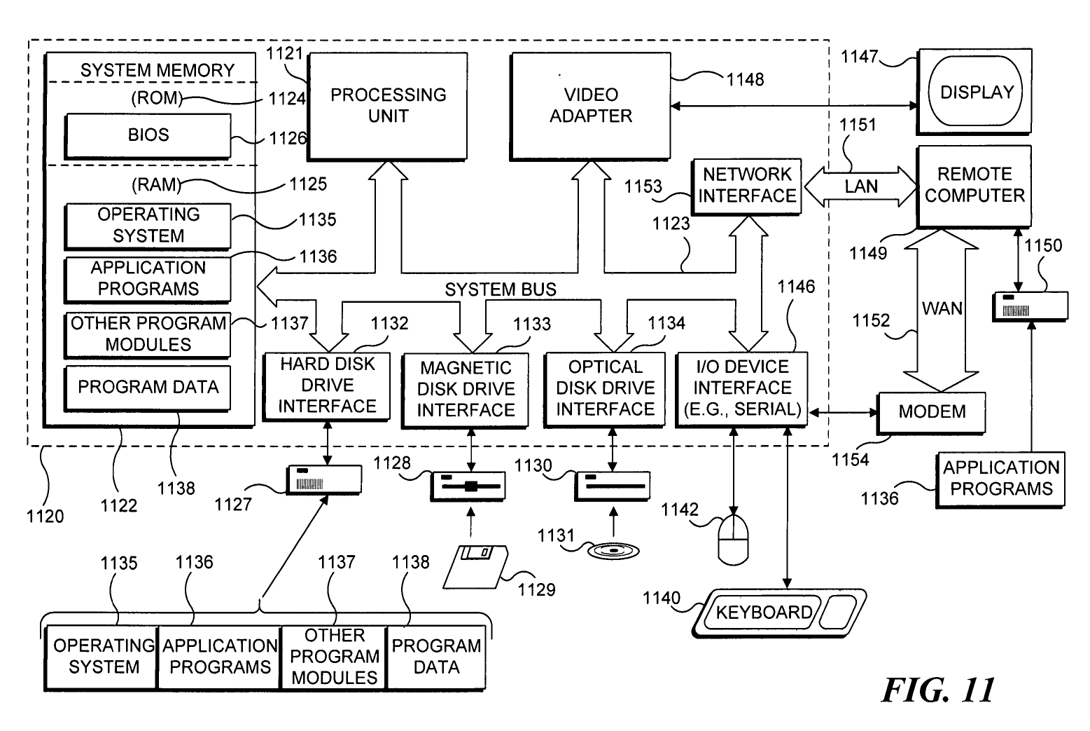

With reference to FIG. 11, an exemplary system suitable for implementing various portions of the present invention is shown. The system includes a general purpose computing device in the form of a conventional PC 1120, provided with a processing unit 1121, a system memory 1122, and a system bus 1123. The system bus couples various system components including the system memory to processing unit 1121 and may be any of several types of bus structures, including a memory bus or memory controller, a peripheral bus, and a local bus using any of a variety of bus architectures. The system memory includes read only memory (ROM) 1124 and random access memory (RAM) 1125. A basic input/output system 1126 (BIOS), containing the basic routines that help to transfer information between elements within the PC 1120, such as during start up, is stored in ROM 1124. PC 1120 further includes a hard disk drive 1127 for reading from and writing to a hard disk (not shown), a magnetic disk drive 1128 for reading from or writing to a removable magnetic disk 1129, and an optical disk drive 1130 for reading from or writing to a removable optical disk 1131, such as a compact disk-read only memory (CD-ROM) or other optical media. Hard disk drive 1127, magnetic disk drive 1128, and optical disk drive 1130 are connected to system bus 1123 by a hard disk drive interface 1132, a magnetic disk drive interface 1133, and an optical disk drive interface 1134, respectively. The drives and their associated computer readable media provide nonvolatile storage of computer readable machine instructions, data structures, program modules, and other data for PC 1120. Although the exemplary environment described herein employs a hard disk, removable magnetic disk 1129, and removable optical disk 1131, it will be appreciated by those skilled in the art that other types of computer readable media, which can store data and machine instructions that are accessible by a computer, such as magnetic cassettes, flash memory cards, digital video disks (DVDs), Bernoulli cartridges, RAMs, ROMs, and the like, may also be used in the exemplary operating environment.

A number of program modules may be stored on the hard disk, magnetic disk 1129, optical disk 1131, ROM 1124, or RAM 1125, including an operating system 1135, one or more application programs 1136, other program modules 1137, and program data 1138. A user may enter commands and information in PC 1120 and provide control input through input devices, such as a keyboard 1140 and a pointing device 1142. Pointing device 1142 may include a mouse, stylus, wireless remote control, or other pointer. Other input devices (not shown) may include a microphone, joystick, haptic joystick, yoke, foot pedals, game pad, satellite dish, scanner, camera, or the like. These and other input/output (I/O) devices are often connected to processing unit 21 through an I/O interface 1146 that is coupled to the system bus 1123. The term I/O interface is intended to encompass each interface specifically used for a serial port, a parallel port, a game port, a keyboard port, and/or a universal serial bus (USB). A display 1147 can be connected to system bus 1123 via an appropriate interface, such as a video graphics adapter 1148. It will be appreciated that PCs are often coupled to other peripheral output devices (not shown), such as speakers (through a sound card or other audio interface—not shown) and printers.

The present invention may be practiced on a single machine, although PC 1120 can also operate in a networked environment using logical connections to one or more remote computers, such as a remote computer 1149. Remote computer 1149 may be another PC, a server (which is typically generally configured much like PC 1120), a router, a network PC, a peer device, or a satellite or other common network node, and typically includes many or all of the elements described above in connection with PC 1120, although only an external memory storage device 1150 has been illustrated in FIG. 11. The logical connections depicted in FIG. 11 include a local area network (LAN) 1151 and a wide area network (WAN) 1152. Such networking environments are common in offices, enterprise wide computer networks, intranets, and the Internet.

When used in a LAN networking environment, PC 1120 is connected to LAN 1151 through a network interface or adapter 1153. When used in a WAN networking environment, PC 1120 typically includes a modem 1154, or other means such as a cable modem, Digital Subscriber Line (DSL) interface, or an Integrated Service Digital Network (ISDN) interface for establishing communications over WAN 1152, such as the Internet. Modem 1154, which may be internal or external, is connected to the system bus 1123 or coupled to the bus via I/O device interface 1146, i.e., through a serial port. In a networked environment, program modules, or portions thereof, used by PC 1120 may be stored in the remote memory storage device. It will be appreciated that the network connections shown are exemplary and other means of establishing a communications link between the computers may be used, such as wireless communication and wide band network links.

Although the present invention has been described in connection with the preferred form of practicing it and modifications thereto, those of ordinary skill in the art will understand that many other modifications can be made to the present invention within the scope of the claims that follow. Accordingly, it is not intended that the scope of the invention in any way be limited by the above description, but instead be determined entirely by reference to the claims that follow.

The invention in which an exclusive right is claimed is defined by the following:

1. A method for displaying a page layout view of a spreadsheet application to present a spreadsheet as it will appear in a printable form, while still enabling editing of data cell content, comprising the steps of:
(a) determining page layout parameters of a printable page using current settings of the spreadsheet application, the page layout parameters including:
(i) a page size;
(ii) a page orientation; and
(iii) page margins;
(b) forming a rectangle incorporating the page layout parameters of the printable page, the rectangle including:
(i) a rectangle perimeter representing outer dimensions of the page size;
(ii) a rectangle orientation representing the page orientation; and
(iii) a rectangle border within the rectangle perimeter, the rectangle border representing the page margins;
(c) determining a cell area available for presenting editable data cells, the cell area including an area of the rectangle surrounded by the rectangle border;
(d) identifying a plurality of editable data cells that can be fitted within the cell area;
(e) inserting the plurality of editable data cells within the cell area of the rectangle; and
(f) generating the rectangle for display.

2. The method of claim 1, further comprising the step of generating a plurality of rectangles, each of the plurality of rectangles including spreadsheet content and representing a corresponding printable page.

3. The method of claim 2, wherein the plurality of rectangles includes one of a range of user-selected editable data cells and all of the occupied editable data cells within the spreadsheet.

4. The method of claim 2, further comprising the step of generating a portion of the plurality of rectangles for display, the portion of the plurality of rectangles generated being determined by a portion of the plurality of rectangles can be fitted in a display area.

5. The method of claim 4, wherein the portion of the plurality of rectangles that can be fitted in the display area is determined by:
(a) a zoom level of the spreadsheet application; and
(b) a size of a viewing area allotted for display of the rectangles.

6. The method of claim 2, further comprising the step of generating a first rectangle adjacent to a second rectangle when the first rectangle presents first editable data cells sequentially adjacent to second editable data cells that are presented in the second rectangle.

7. The method of claim 2, further comprising the steps of:
(a) monitoring a position of a cell cursor, the position of the cell cursor indicating a current cell;
(b) identifying the current cell within the plurality of rectangles;
(c) identifying a rectangle that includes the current cell, from among the plurality of rectangles, as a current rectangle; and
(d) generating the current rectangle for display.

8. The method of claim 7, further comprising the steps of:
(a) determining whether the current rectangle includes a position-specific object, the position specific object including an object associated with at least one object data cell; and
(b) generating the position specific object when the at least one object data cell associated with the position specific object is included in the portion of the plurality of rectangles generated for display.

9. The method of claim 7, further comprising the step of distinguishing at least one active rectangle including a portion of the spreadsheet to be printed from at least one inactive rectangle including a portion of the spreadsheet that is not to be printed by making at least one visible attribute of the at least one active rectangle different from the at least one inactive rectangle.

10. The method of claim 9, wherein the visible attribute includes a rectangle color, and wherein the at least one active rectangle is presented with an active rectangle color in contrast with inactive rectangles that are presented with an inactive rectangle color.

11. The method of claim 1, further comprising the step of presenting row and column identifiers associated with the plurality of editable data cells outside the rectangle perimeter.

12. The method of claim 1, further comprising the step of presenting editable margin content in the rectangle border, the editable margin content being disposed in the rectangle border to represent how the editable margin content will appear in the printable form.

13. The method of claim 12, further comprising the step of permitting a user to edit the editable margin content, including the steps of:
(a) detecting a user selection of a portion of the rectangle border where the editable margin content is disposed;
(b) accepting user input to the portion of rectangle border; and
(c) continuing to display other portions of the rectangle while accepting user input to the portion of the rectangle border.

14. The method of claim 12, further comprising the steps of:
(a) disposing a header area and a footer area within the rectangle border; and
(b) subdividing the header area and the footer area into a plurality of alignment ranges disposed at an alignment position, such that text is aligned corresponding to the alignment position.

15. The method of claim 1, further comprising the steps of:
(a) presenting graphical representations of page margins;
(b) enabling a user to graphically manipulate the graphical representations of page margins to change a size of the page margins; and
(c) adjusting the size of the rectangle border representing the page margins to reflect any change in the size of the page margins.

16. The method of claim 15, further comprising the step of presenting at least one ruler outside the rectangle perimeter, the at least one ruler assisting a user viewing or adjusting the page margins.

17. The method of claim 1, further comprising the step of providing a attribute palette, the attribute palette presenting a plurality of visible attributes assignable to portions of the rectangle and viewable in the rectangle when applied.

18. The method of claim 1, further comprising the step of providing selectable display modes enabling a user to select between the page layout view and a cell-based view, the cell-based view being configured to display the editable data cells without being affected by the page layout parameters.

19. The method of claim 18, further comprising the step of providing a view selector enabling a user to choose one of the page layout view and the cell-based view by selecting a representative icon corresponding thereto.

20. A memory medium having machine executable instructions for carrying out the steps of claim 1.

21. A method for displaying a page layout view of a spreadsheet application to present a spreadsheet as it will appear in a printable form, comprising the steps of:
(a) determining page layout parameters of a printable page using current settings of the spreadsheet application, the page layout parameters including:
(i) a page size;
(ii) a page orientation; and
(iii) page margins;
(b) forming an active rectangle as a function of the page layout parameters of the printable page, the active rectangle including:
(i) a rectangle perimeter representing outer dimensions of the page size;
(ii) a rectangle orientation representing the page orientation; and
(iii) a rectangle border disposed within the rectangle perimeter, the rectangle border representing the page margins;
(c) determining a cell area available for presenting editable data cells, the cell area including an area of the rectangle surrounded by the rectangle border;
(d) identifying a plurality of editable data cells that fit within the cell area;
(e) inserting the plurality of editable data cells within the cell area of the rectangle;
(f) generating the active rectangle for display to a user;
(g) forming at least one inactive rectangle indicating at least one of a presence and a position of inactive pages including cell areas not designated for printing;
(h) generating at least a portion of the at least one inactive rectangle, the at least one inactive rectangle being generated with a visual attribute different from the at least one active rectangle;
(i) enabling the user to selectively edit the plurality of editable data cells while the page layout view is displayed.

22. The method of claim 21, further comprising the step of forming a plurality of rectangles, each of the plurality of rectangles representing a corresponding printable page.

23. The method of claim 22, wherein the plurality of rectangles includes one of:
(a) a range of user-selected editable data cells; and
(b) all of the occupied editable data cells within the spreadsheet.

24. The method of claim 22, further comprising the step of generating a portion of the plurality of rectangles for display, the portion of the plurality of rectangles generated being able to fit in a display area.

25. The method of claim 22, further comprising the steps of:
(a) monitoring a position of a cell cursor, the position of the cell cursor indicating a current cell;
(b) identifying a current rectangle as a rectangle from among the plurality of rectangles that includes the current cell; and
(c) generating the current rectangle for display to the user.

26. The method of claim 25, further comprising the steps of:
(a) determining whether the current rectangle includes a position-specific object, the position specific object including an object associated with at least one object data cell; and
(b) generating the position specific object when the at least one object data cell associated with the position specific object is included in the portion of the plurality of rectangles generated for display.

27. The method of claim 25, further comprising the step of visually distinguishing at least one active rectangle including a portion of the spreadsheet to be printed from at least one inactive rectangle including a portion of the spreadsheet that is not to be printed by making at least one visible attribute of the at least one active rectangle different from the at least one inactive rectangle.

28. The method of claim 22, further comprising the step of presenting an editable margin content in the rectangle border, the editable margin content being disposed in the rectangle border to represent how the editable margin content will appear in a printable form

29. The method of claim 28, further comprising the step of permitting a user to edit the editable margin content, including the steps of:
(a) detecting a user selection of a portion of the rectangle border where the editable margin content is disposed;
(b) accepting a user input to the portion of rectangle border; and
(c) continuing to display other portions of the rectangle while accepting the user input to the portion of the rectangle border.

30. The method of claim 21, further comprising the step of providing selectable display modes enabling a user to select between the page layout view and a cell-based view, the cell-based view being configured to display the editable data cells without being affected by the page layout parameters.

31. The method of claim 30, further comprising the step of providing a view selector enabling a user to choose one of the page layout view and the cell-based view by selecting a representative icon corresponding thereto.

32. A memory medium having machine executable instructions for carrying out the steps of claim 21.

33. A system for displaying a page layout view of a spreadsheet application to present a spreadsheet as it will appear in a printable form, comprising:
(a) at least one user input device;
(b) a display screen;
(c) a processor in communication with the input device and the display screen; and
(d) a memory in communication with the processor, the memory storing data and machine instructions that cause the processor to carry out a plurality of functions, including:
(i) determining page layout parameters of a printable page producible using current settings of the spreadsheet application, the page layout parameters including:
(A) a page size;
(B) a page orientation; and
(C) page margins;
(ii) forming a rectangle as a function of the page layout parameters of the printable page, the rectangle including:
(A) a rectangle perimeter representing outer dimensions of the page size;
(B) a rectangle orientation representing the page orientation; and
(C) a rectangle border disposed within the rectangle perimeter, the rectangle border representing the page margins;
(iii) determining a cell area available for presenting editable data cells, the cell area including an area of the rectangle surrounded by the rectangle border;
(iv) identifying a plurality of editable data cells that fit within the cell area;
(v) inserting the plurality of editable data cells within the cell area of the rectangle; and
(vi) generating the rectangle for display on the display screen.

34. The system of claim 33, wherein the machine instructions stored in the memory further cause the processor to form a plurality of rectangles, each of the plurality of rectangles representing a corresponding printable page.

35. The system of claim 34, wherein the plurality of rectangles includes one of
(a) a range of user-selected editable data cells; and
(b) all of the occupied editable data cells within the spreadsheet.

36. The system of claim 34, wherein the machine instructions stored in the memory further cause the processor to generate a portion of the plurality of rectangles for display on the display screen, the portion of the plurality of rectangles generated being able to fit in a display area of the display screen.

37. The system of claim 34, wherein the machine instructions stored in the memory further cause the processor to:
(a) monitor a position of a cell cursor, the position of the cell cursor indicating a current cell;
(b) identify a current rectangle as a rectangle from among the plurality of rectangles that includes the current cell; and
(c) generate the current rectangle for display on the display screen.

38. The system of claim 37, wherein the machine instructions stored in the memory further cause the processor to:
(a) determine whether the current rectangle includes a position-specific object, the position specific object including an object associated with at least one object data cell; and
(b) generate the position specific object when the at least one object data cell associated with the position specific object is included in the portion of the plurality of rectangles generated for display on the display screen.

39. The system of claim 37, wherein the machine instructions stored in the memory further cause the processor to visually distinguish the at least one active rectangle including a portion of the spreadsheet to be printed from at least one inactive rectangle including a portion of the spreadsheet that is not to be printed by making at least one visible attribute of the at least one active rectangle different from the at least one inactive rectangle.

40. The system of claim 33, wherein the machine instructions stored in the memory further cause the processor to provide a view selector enabling a user to choose one of the page layout view and acell-based view by selecting a representative icon thereto, the cell-based view being configured to display the editable data cells without being affected by the page layout parameters.
